(19) United States
(12) Patent Application Publication
(10) Pub. No.: US 2025/0272679 A1
(43) Pub. Date: Aug. 28, 2025

(54) TRUSTED REMOTE SENSOR FUSION AND EVENTUAL CONSISTENCY FOR DISTRIBUTED WORKFLOWS IN SUPPLY-CHAIN-AS-A-SERVICE (SCAAS) BLOCKCHAIN SOLUTION

(71) Applicant: HITACHI, Ltd., Tokyo (JP)

(72) Inventors: Prasun SINGH, San Jose, CA (US); Ravigopal VENNELAKANTI, San Jose, CA (US); Malarvizhi SANKARANARAYANASAMY, Mountain View, CA (US)

(21) Appl. No.: 18/587,844

(22) Filed: Feb. 26, 2024

(51) Int. Cl. G06Q 20/38; G06Q 20/22; G06Q 20/36

(52) U.S. Cl. CPC G06Q 20/389; G06Q 20/223; G06Q 20/3672

(57) ABSTRACT

Systems and methods directed to establishing a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain; and for the PRBP detecting a connection failure for the remote blockchain node, issuing a Connection Failed Non-Fungible Token (CF-NFT) to partner peer nodes of the SCaaS blockchain.

### BACKGROUND

### Field

The present disclosure is generally directed to sensor systems, and more specifically, to sensor fusion systems having Supply-Chain-As-A-Service (SCAAS) blockchain solutions to achieve eventual consistency for remote sensor fusion through Non-Fungible Tokens (NFTs).

### Related Art

FIG. 1 illustrates an example of a single-echelon supply chain network involving only direct partners. In a traditional enterprise resource planning (ERP) system, the supply chain parent company is mostly integrated with direct partners of the value chain that are in a permanent relationship with the supply chain network. The goal is to optimize the supply chain among immediate partners and attain efficiencies.

Due to the global nature of the modern supply chain network and the need to manage disruptions, there is need to integrate with indirect partners of the supply chain. These indirect partners may have a transient relationship in the supply chain, but there is no easy way to integrate them into current supply chain systems and build a single truth for operations and analytics.

In the related art, the ERP systems have a minimal Internet of Things (IoT) network and lacks sensor data integration for integrated operational processes views. Most ERP systems are designed for local efficiency over global maxima. These systems are architected for consistency over availability while having a fair amount of partition tolerance.

FIG. 2 illustrates an example of a multi-echelon supply chain network. Specifically, the example of FIG. 2 illustrates three levels of direct and indirect partners. In the example of FIG. 2, the supply chain parent company has integrated not only with its direct partners of the value chain, but also with the indirect partners across having multi-echelon visibility into the supply chain network. Multi-echelon supply chain networks are designed for supply chain resiliency. For example, during disruptions, the multi-echelon supply chain can involve strategies to survive, to recover, and/or to heal according to tradeoffs between efficiency versus being responsive.

In a multi-echelon supply chain network, companies can facilitate a path to bring direct and indirect supply chain partners in an integrated ecosystem network for single truth in global supply chain networks. Multi-echelon supply chain networks also facilitate the ability to implement IoT and sensor fusion for supply chain visibility and process automation by laying the foundations for track and trace (traceability) across the supply chain.

Supply chain management needs to be offered as a Supply-Chain-as-a-Service (SCaaS) that require appropriate architecture design for balancing the availability and consistency with partition tolerance.

FIG. 3 illustrates an example of a blockchain SCaaS solution architecture.

Blockchain has emerged as a candidate for building the next generation of supply chain management solutions. Although blockchain started as public distributed system, it has evolved to also support the needs of an enterprise blockchain. With respect to the blockchain SCaaS solution, the data capture and integration layer provides data from IoT devices, external data systems and ERP systems of partners in the supply chain network, for building some of the SCaaS Platform services.

The blockchain distributed ledger has the single truth among the consortium partners due to consensus mechanisms. Smart contracts automate the business process workflows leveraging IoT and analytics with a single truth for the blockchain. The SCaaS has a suite of micro applications/applications for targeted functional areas of the SCaaS stakeholders or users of the system.

Requirements for an enterprise blockchain solution can include, but is not limited to, permissioned network, governance model for the supply chain consortium, ensure confidentiality and privacy for supply chain partners, consensus for single truth, smart contracts for automation of business processes, and so on. The smart contract is a term used to describe computer code that automatically executes all or parts of an agreement, and is stored on a blockchain-based platform.

FIG. 4 illustrates an example of an IoT sensor fusion and blockchain solution, in accordance with an example implementation.

The industrial blockchain network has the supply chain partner organization blockchain (BC) nodes that receive transactions submitted from client applications or sensor nodes onto a single truth distributed BC ledger. BC smart contracts and IoT provide automation to achieve business process efficiencies as in the example as follows from FIG. 4.

Sensor fusion from video/image sensors at customer (A) warehouse detects low inventory of goods/product. A sales order (SO) is generated by smart contract that refers to the agreed pricing on the BC ledger between customer (A) and parent company (B) and sends to parent company (B).

Parent company (B) receives SO from customer (A) and sends a purchase order (PO) to Supplier (C). Sensor fusion from factories of Supplier (C) can send the manufacturing status to partners in the BC Network.

Supplier (C) requests logistics company (D) to ship its products to the warehouse of parent company (E) with shipment condition monitoring using sensors, such as sensors for location and temperature. Non-compliance during shipment are enforced by smart contracts between the partners.

Sensor fusion from sensors at parent company warehouse (E) detects goods received at location from supplier (C) and smart contract can make payments to supplier (C) from parent company (B).

Parent company (B) requests logistics company (F) to ship its products to the warehouse of customer company (A) with shipment condition monitoring using sensors such as sensors for location and temperature. Non-compliance during shipment are enforced by smart contracts between the partners.

Sensor fusion from sensors at customer warehouse (A) detects goods received at location from warehouse (E) and smart contract can make payments to parent company (B) from to customer (A).

FIG. 5 illustrates an example of sensor fusion modeling for SCaaS. For the sensor fusion modeling for SCaaS involves bounded local sensor networks such as remote and intermittently connected sites (e.g., video and image capture sensors, LiDAR sensors, temperature, humidity sensors, location sensors, and so on), distributed multi-site sensor networks (e.g., supply chain partner configurations, regional warehouse allocation assignments, warehouse connectivity levels, and so on), and external data (commodity price index, macro-economic trends, regulatory trends, weather, and so on).

Sensor fusion processing levels can involve various levels. In level zero, the processing can involve signal/feature extraction and assessment, such as from raw readings from sensors.

In level one, the processing can involve an entity assessment (e.g., object detection/recognition, product rack mapping, order dispatch detection). In level two, the processing can involve a situation assessment (e.g., shipment delay risk, storage condition non-compliance). In level three, the processing can involve impact assessment (e.g., shipment contract non-compliance impacts, power outage impacts). In level four, the processing can involve sensing process assessment (e.g., IoT Instrumentation Trust, Supplier Site Quality of Service (QOS), Logistics Tracking QoS).

Outputs of the sensor fusion processing can involve Supply Chain Event of Interest (EoI) (e.g., shipment order loaded to truck, truck with truckID has a high temperature level, shipment order received at a location, shipment order delayed, and so on). Further output can involve supply chain information (e.g., perishable inventory list, supplier QoS report, shipment delay mitigation agreements, product stocking area allocations, shipping consignment track and trace, and so on).

### SUMMARY

One example problem in blockchain SCaaS involves a halt in workflow. The halt in workflow continuation can be due to a lack of trust in sensor fusion- and/or outage at the remote site participating in a distributed workflow. In an example, the distributed workflow in the blockchain SCaaS can be halted due to a failure to obtain transaction endorsements and/or validation from remote partner sites due to a connection failure in the remote blockchain node to the industrial blockchain network, or a failure of trust in sensor nodes for sensor fusion events or transactions submitted to the industrial blockchain network.

FIG. 6 illustrates an example problem involving trust in transactions from the partner remote site. In another example problem in blockchain SCaaS, there can be failures in sensors and/or trust in transactions from the partner remote site. Various failure states of the sensor fusion in the SCaaS blockchain network can be as follows.

Remote Blockchain (RBC) Node to main SCaaS Blockchain network Connection Failure: RBC Node stopped working with main SCaaS Blockchain network and results in a fail stop.

Aggregators and Edge Node (AEN) Failure: a) AEN stopped working, b) AEN is working but output data are faulty and unreliable, and/or c) No trust in identity or Root of Trust (ROT) for AEN device.

Sensor Node (SN) Failure: a) SN stopped working, b) SN is working but SN data are faulty and unreliable, and/or c) No trust in identity or ROT for SN device.

Sensor(S) Failure: a) Sensor stopped working resulting in a fail stop b) Sensor is working but sensor readings are faulty c) No trust in identity or ROT for sensor device.

FIG. 7 illustrates an example of potential failure states in SCaaS Blockchain Solution. Blockchain nodes of supply chain partners in the industrial blockchain are trusted and fault tolerant for validations and endorsements of transactions as they are setup as trusted peer nodes with known enterprise identities (as private or permissioned blockchain) with eventual consistency ensured by a blockchain consensus mechanism. However, remote site partner peer nodes that generate supply chain Events-of-Interest (EoI) from sensor fusion and submit to peer nodes of Industrial Blockchain operate outside the enterprise governance of Industrial Blockchain and hence their trust in such workflows need to be verified (i.e., trust but verify).

During periods of connection failure of remote site nodes, the EoI generated from sensor fusion are not accepted/committed by the partner peer nodes of the Industrial Blockchain and the distributed workflow halts or need to be canceled resulting in a failure state due to connection failure of partner remote site.

Further, industrial blockchain partners may not have trust in measurements and identity of sensor nodes at remote site used for sensor fusion. For example, sensor fusion outputs (e.g EoI) submitted by Remote Blockchain Node may require on-demand re-verification for the distributed workflow of the industrial blockchain consortium, resulting in a Byzantine failure state.

Example implementations described herein are directed to solutions for sensor fusion failure scenarios. Such scenarios can involve the connection failure of Remote BC Node (RBN) to SCaaS blockchain network, or a Byzantine failure (malicious behavior) of AEN and SN sensor network devices.

Aspects of the present disclosure can include a method, which can involve establishing a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain; and for the PRBP detecting a connection failure for the remote blockchain node, issuing a Connection Failed Non-Fungible Token (CF-NFT) to partner peer nodes of the SCaaS blockchain.

Aspects of the present disclosure can include a computer program, having instructions for executing a process involving establishing a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain; and for the PRBP detecting a connection failure for the remote blockchain node, issuing a Connection Failed Non-Fungible Token (CF-NFT) to partner peer nodes of the SCaaS blockchain. The computer program and instructions can be stored on a non-transitory computer readable medium and executed by one or more processors.

Aspects of the present disclosure can include a system, which can involve means for establishing a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain; and for the PRBP detecting a connection failure for the remote blockchain node, means for issuing a Connection Failed Non-Fungible Token (CF-NFT) to partner peer nodes of the SCaaS blockchain.

Aspects of the present disclosure can involve an apparatus configured to function as a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain, the apparatus including a processor, configured to, for detection of a connection failure for the remote blockchain node, issuing a Connection Failed Non-Fungible Token (CF-NFT) to partner peer nodes of the SCaaS blockchain.

### BRIEF DESCRIPTION OF THE DRAWINGS

FIG. 1 illustrates an example of a single-echelon supply chain network involving only direct partners.

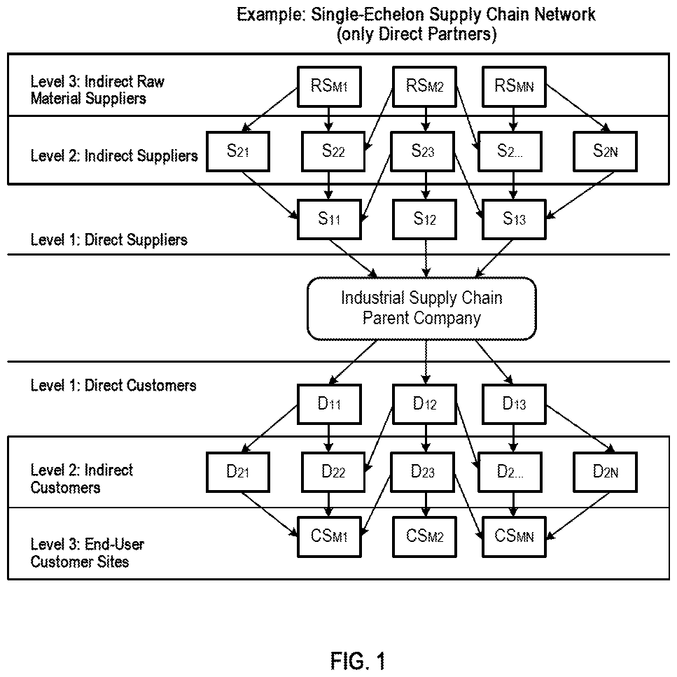

FIG. 2 illustrates an example of a multi-echelon supply chain network.

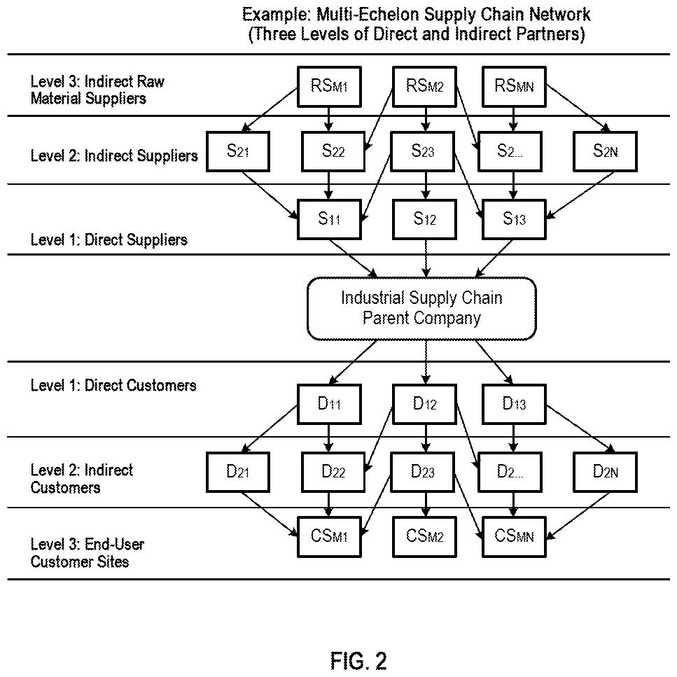

FIG. 3 illustrates an example of a blockchain SCaaS solution architecture.

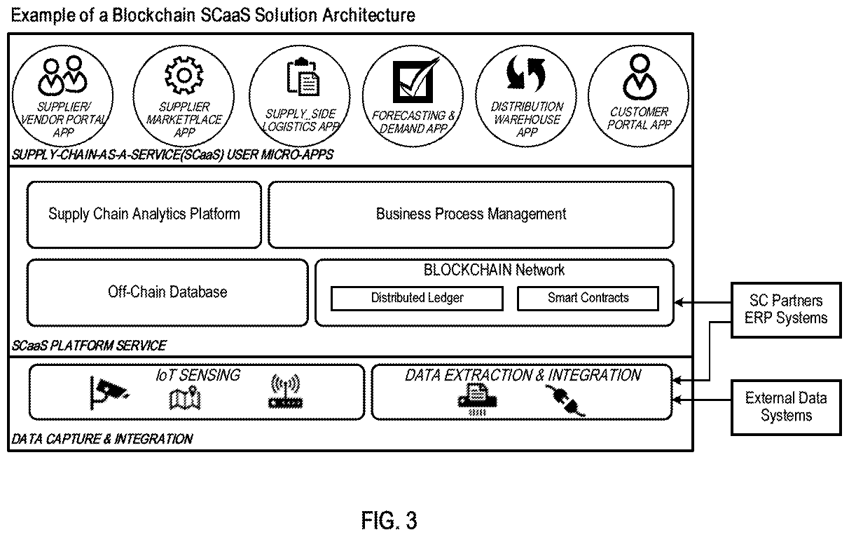

FIG. 4 illustrates an example of an IoT sensor fusion and blockchain solution, in accordance with an example implementation.

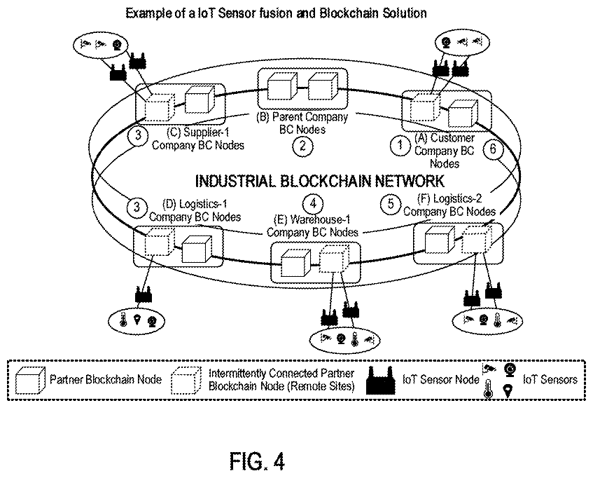

FIG. 5 illustrates an example of sensor fusion modeling for SCaaS.

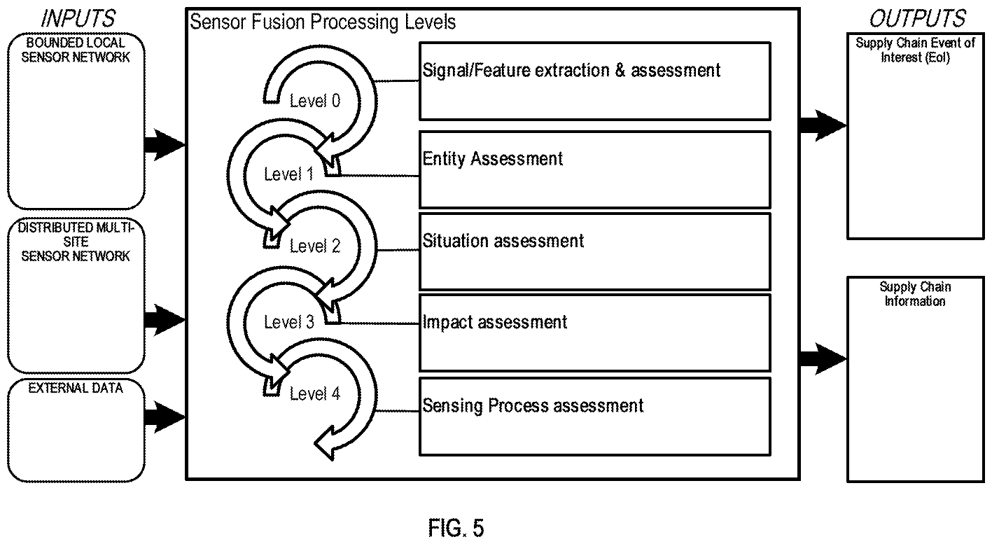

FIG. 6 illustrate an example problem involving trust in transactions from the partner remote site.

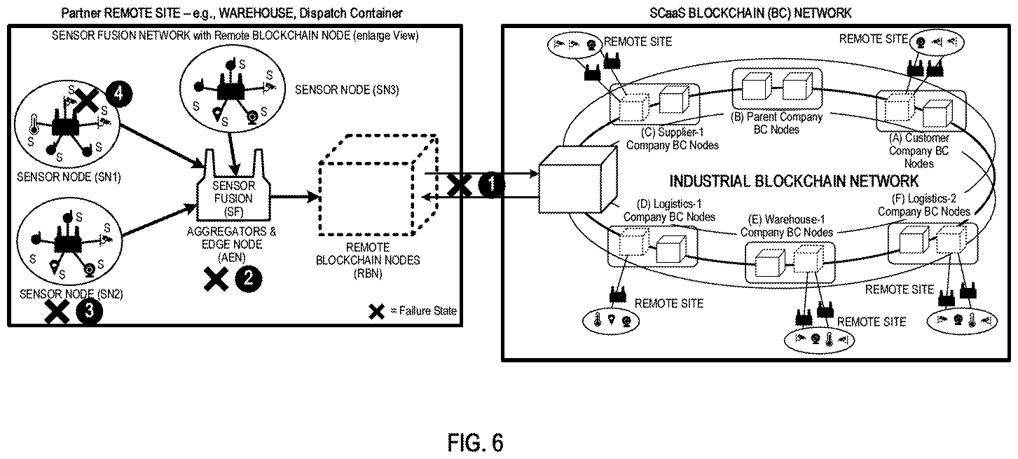

FIG. 7 illustrates an example of potential failure states in SCaaS Blockchain Solution.

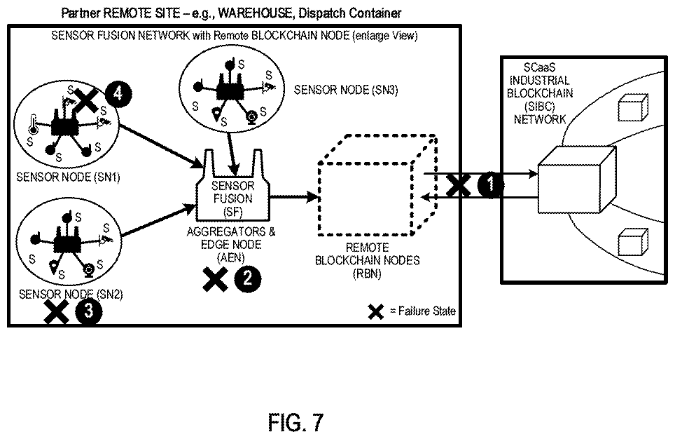

FIG. 8 illustrates an example overview of the system upon which example implementations can be applied.

FIG. 9 illustrates the system process to establish the Local Sensor Fusion Blockchain (LSFBC) Network, in accordance with an example implementation.

FIG. 10 illustrates an example of the system process to establish proxy remote BC Node (PRBP) as another peer in the BC peer group of the supply chain partner, in accordance with an example implementation.

FIG. 11 illustrates the system process for the sensor fusion trust modeling, in accordance with an example implementation.

FIG. 12 illustrates the example process for the trust modeler in AEN or the dedicated local system, in accordance with an example implementation.

FIG. 13 illustrates an example system process for the sensor fusion modeling and output, in accordance with an example implementation.

FIG. 14 illustrates an example of the system process for sensor fusion modeling and output, in accordance with an example implementation.

FIG. 15 illustrates an example of the system process for the situation when the on connection is available for the remote site with SIBC, in accordance with the desired implementation.

FIG. 16 illustrates an example system process for when the connection failed from the remote site to the SCaaS Blockchain Network, in accordance with an example implementation.

FIG. 17 illustrates an example of the system process to achieve eventual consistency for a distributed workflow among SCaaS partners in an industrial blockchain network, in accordance with an example implementation.

FIG. 18 illustrates an example solution formulation, in accordance with an example implementation.

FIG. 19 illustrates an example computing environment with an example computer device suitable for use in some example implementations.

### DETAILED DESCRIPTION OF THE INVENTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

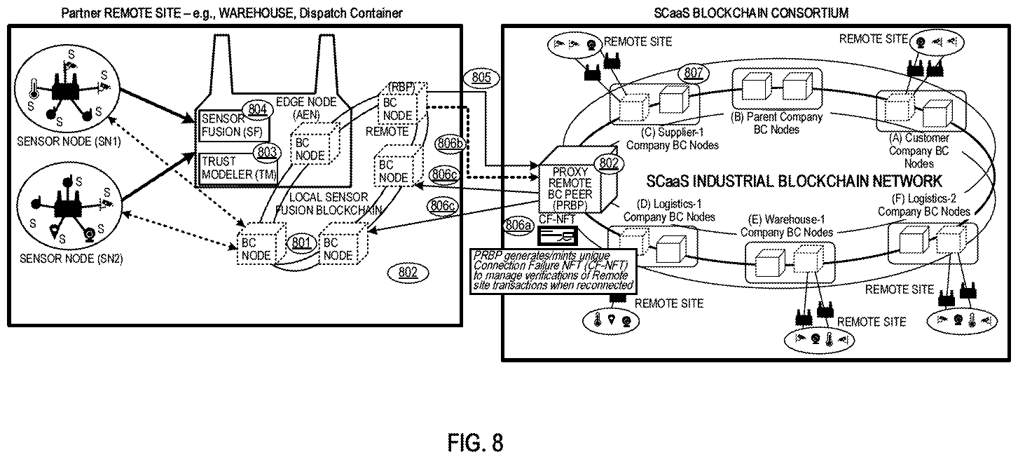

FIG. 8 illustrates an example overview of the system upon which example implementations can be applied.

At 801, the system establishes the Local Sensor Fusion Blockchain (LSFBC) Network. A Sensor Fusion BC network at a remote site is configured and set up to provide a local single truth of sensor devices and operations. Groups of SN, AEN are assigned to BC peer nodes and one of the Remote BC peer node (RBP) can act as client for submitting transactions to the SCaaS blockchain network.

At 802, the system establishes a Proxy Remote BC Node (PRBP). In the partner organization having a remote site, the system assigns one peer as PRBP of the SCaaS blockchain network that receives sensor fusion transactions submitted by the remote blockchain node of the remote site.

At 803, sensor fusion trust modeling is executed. The trust modeler at the AEN builds Proof-of-Trust as a Local Trust Level (LTL) from the Local Sensor Fusion Blockchain (LSFBC) distributed ledger, with the peer nodes having configurations and device trust data (e.g., Root of Trust, device attestations, origin, and so on) and information from sensor device suppliers/service providers as needed.

At 804, sensor fusion modeling and output is executed. Sensor fusion (SF) at AEN generates output transactions such as supply chain Event-of-Interest (EoI) that are submitted to the peer nodes of LSFBC. After local consensus, the RBP then submits these transactions to the PRBP of the SCaaS blockchain network.

At 805, the system facilitates an on live (online) connection of the remote site. The remote blockchain peer (RBP) submits transactions/events (EoI) and LTL to the Proxy Remote Node (PRBP) of partner BC node. The PRBP participates in the distributed workflow of the SCaaS Blockchain solution.

On connection failed indicated for the remote site, the system can execute the following.

At 806a, the PRBP detects the connection failure state for remote site and issues a Connection Failed NFT (CF-NFT) that is used to store state of verifications to be done by PRBP for transactions submitted by the RBP after it reconnects.

At 806b, the remote site continues to operate with single truth of its operations available in its LSFBC.

At 806c, on re-connection the RBP sends the missed batch of EoIs and LTL to PRBP. After which based on CT-NFT, the PRBP requests verifications of transactions from other peers of LSFBC to accept transactions submitted by RBP (thereby resolving Byzantine and Sybil issues). The trusted transactions of the remote site are then accepted by PRBP for SCaaS blockchain network.

At 807, the system achieves eventual consistency for sensor fusion transactions in the remote site not under governance by the SCaaS consortium for distributed workflow among permissioned partners in the SCaaS Blockchain.

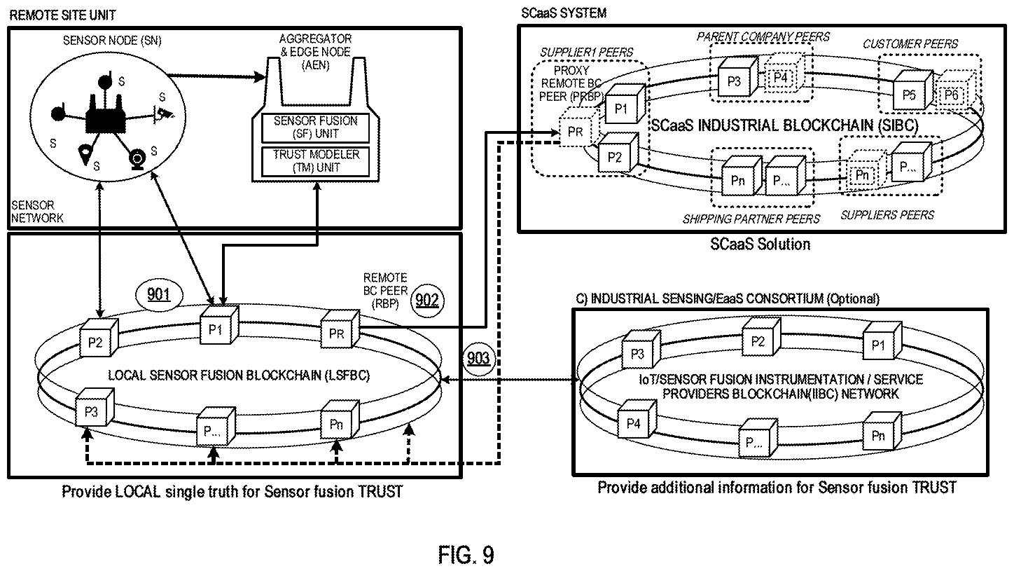

FIG. 9 illustrates the system process to establish the Local Sensor Fusion Blockchain (LSFBC) Network 801, in accordance with an example implementation.

At 901, the system process establishes the Local Sensor Fusion Blockchain (LSFBC) network for the remote site of the supply chain partner in SCaaS Industrial Blockchain Consortium (SIBC). The LSFBC has peer nodes organized as peers (p1, p2, p3, . . . ps) mapped to groups of AENs and Sensor Nodes SNs for immutable records of local sensing configurations and operations. The peers also receive the Event-of-Interest (EoI) from sensor fusion that are submitted to the SIBC for tasks in distributed workflow for Supply Chain Management. There can be many subgroups of peers in LSFBC with varying length of its distributed ledger.

At 902, one of the peers in the LSFBC can be assigned as Remote BC Peer (RBP) node that can act as a client, or can become part of the partner peer node in the SIBC. The RBN is responsible for submitting all EoIs generated at the remote site to the workflows of the SCaaS blockchain by its live connection with SIBC network of SCaaS solution.

At 903, optionally, the LSFBC may be connected to IoT Instrumentation/Service Providers Blockchain (IIBC) network having suppliers and service providers of the sensing devices at remote site to get immutable information for sensing devices such as servicing records, regulatory compliances, quality certificates, ownerships, remote attestations, and so on.

In the system process, several assumptions are made. One assumption is that the RBP role can be randomly rotated among the local peers of the remote site. Another assumption is that the blockchain networks (LSFBC, SIBC, IIBC) are configured for time synchronization with a universal clock such as an NTP time server. Further, another assumption is that the Byzantine behavior of local peer nodes can be locally detected on LSFBC by RBN by its blockchain platform consensus mechanisms before sending to SIBC. The LSFBC and IIBC provide the information to build dynamic Trust Models for Sensor Fusion transactions/events submitted to the SIBC.

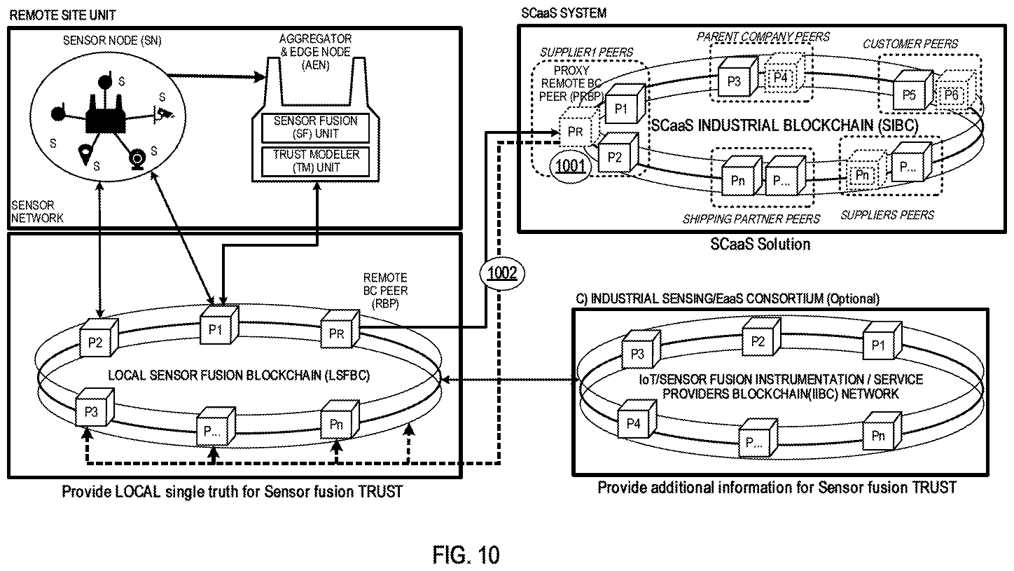

FIG. 10 illustrates an example of the system process to establish proxy remote BC Node (PRBP) as another peer in the BC peer group of the supply chain partner in SIBC, in accordance with an example implementation. In the example implementation, the system establishes the proxy remote BC node (PRBP) as another peer in the BC peer group of the supply chain partner through a process as follows. At 1001, the system establishes the PRBP in the partner organization peer group of SCaaS blockchain network that receives transactions from the RBP of Remote Site. At 1002, when the remote site is connected to SCaaS solution, the remote BC peer (RBP) node instantaneously submits the EoI to the PRBP and the workflow progresses in the SIBC.

In this system process, there are several assumptions. One assumption is that the PRBP node can be rotated among the SCaaS peers in SIBC network. Another assumption is that the PRBP can poll the peers of the LSFBC and get response on validity or more information regarding the supply chain EoI.

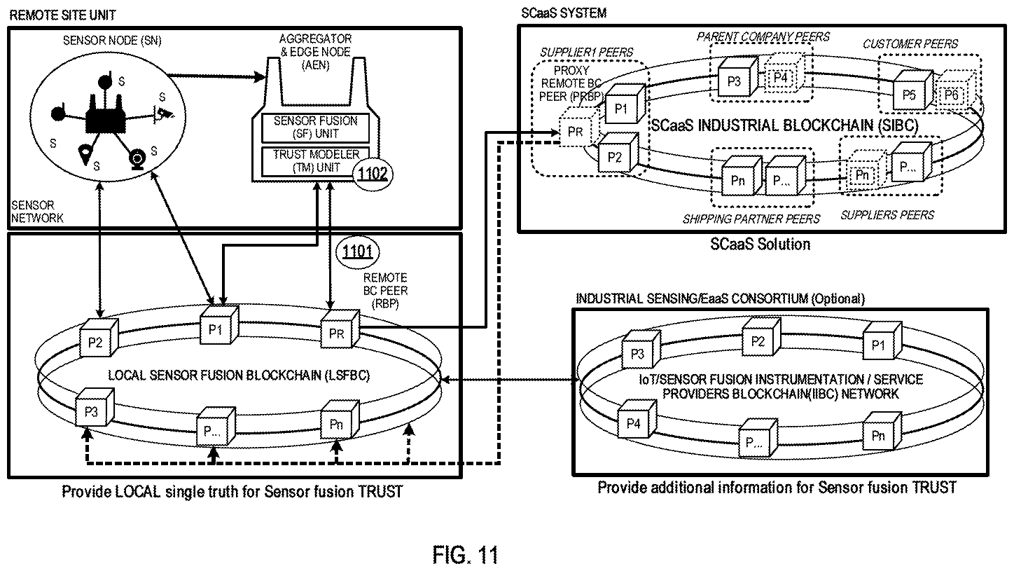

FIG. 11 illustrates the system process for the sensor fusion trust modeling, in accordance with an example implementation. At 1101, the LSFBC peer nodes provides the traceable configurations, identities, Root of Trust (ROT), other data of all sensing devices (S, SN, AEN, and so on) as an immutable ledger on the Local Sensor Fusion Blockchain (LSFBC) at the remote site. At 1102, the Trust Modeler (TM) in AENs or the dedicated local system then computes the Local Trust Level (LTL) output from 1101 for the sensor fusion result/output (e.g., Supply Chain Event-of-Interest (EoI) that is eventually submitted by remote blockchain peer (RBP) to the Proxy Remote BC Peer (PRBP).

Several assumptions are made for the sensor fusion trust modeling. Firstly, it is presumed that the Byzantine behavior of the sensor nodes can be locally detected on LSFBC by RBP by its blockchain consensus mechanisms and is accounted for in Trust Modeling. Further, tasks in the distributed workflow are assumed to have an acceptance level defined for the trust level of EoI that are used in their Smart Contracts. Trust level can be increased by adding more Proof-of-Trust to LTL as demanded by the Supply Chain Partners (e.g. during Byzantine or Connection-Fail)

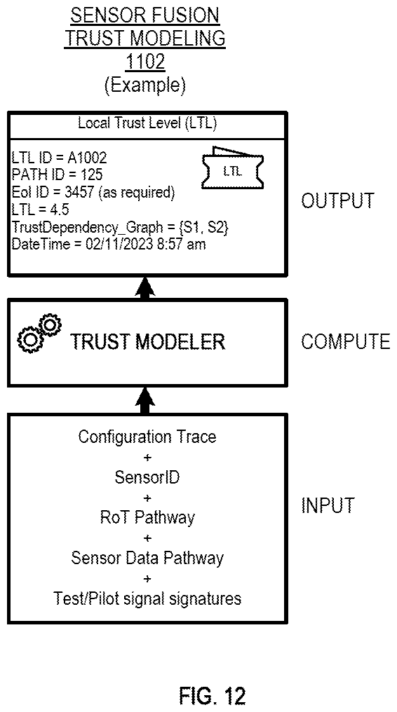

FIG. 12 illustrates the example process for the trust modeler in AEN or the dedicated local system, in accordance with an example implementation. As shown in the flow of FIG. 12, the trust modeler can take in various inputs such as the configuration trace, the sensor identifier, the RoT pathway, the sensor data pathway, the test/pilot signal signatures, and so on in accordance with the desired implementation. This input is then processed by the trust modeler to compute the Local Trust Level (LTL) output. LTL ticket as illustrated in FIG. 12 provides trust level for EoI outputs in LSFBC.

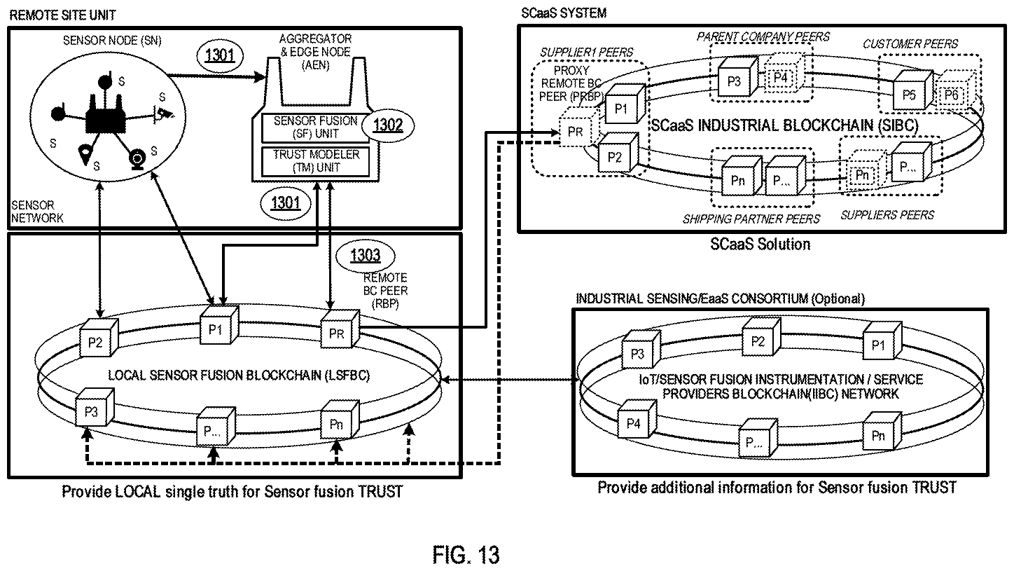

FIG. 13 illustrates an example system process for the sensor fusion modeling and output, in accordance with an example implementation. At 1301, the SNs send sensor data to the AEN that are processed for sensor fusion. The AEN also can extract immutable data from the LSFBC for sensor fusion processing as required.

At 1302, the SF unit in AENs generate/compute the outputs such as supply chain EoIs as part of Sensor Fusion modeling.

At 1303, the AEN then submits the EoI with LTL ticket to the RBP and other peer nodes of LSFBC for validation, endorsement and commitment to their distributed ledger.

To submit the EoI with the LTL ticket, an assumption is made in that EoI and LTL order local sequencing/ordering is validated by RBP by its blockchain consensus mechanisms providing the EoI sequencing guarantee as required.

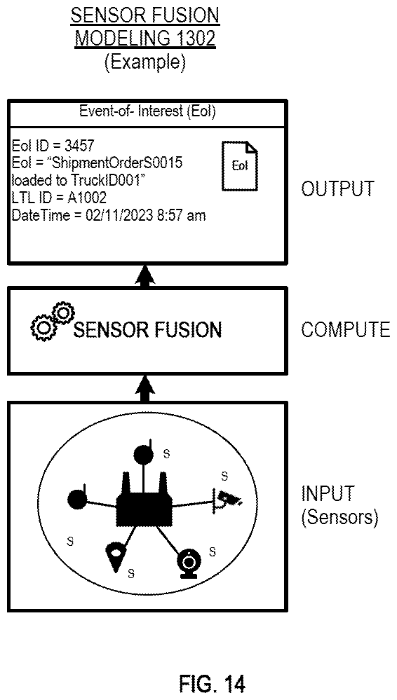

FIG. 14 illustrates an example of the system process for sensor fusion modeling and output, in accordance with an example implementation. An example of input can involve sensors of any kind, in accordance with the desired implementation. Such sensor data can be provided through a sensor fusion to compute the output for the EoI, in accordance with the desired implementation.

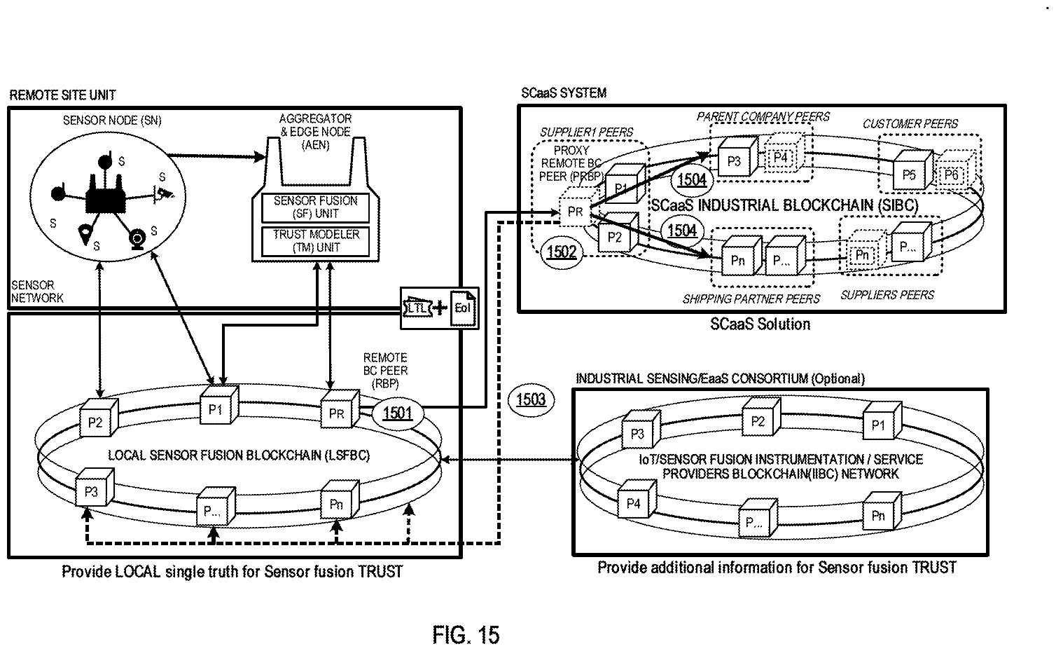

FIG. 15 illustrates an example of the system process for the situation when the on connection (online) is available for the remote site with SIBC, in accordance with the desired implementation.

At 1501, the Remote BC Peer (RBP) eventually obtains a consistent EoI with LTL ticket submitted by the AEN as a new transaction on its ledger, and is ready to send this transaction to PRBP when connection is detected.

At 1502, the Remote BC Peer (RBP) immediately submits the EoI transaction with its LTL finalized on its ledger to the PRBP of SIBC.

At 1503, the PRBP receives the EoI and LTL and establishes trust (RootofTrust, correctness) in RBP. In case the PRBP is not able to establish RBP trust or has only—a low level of trust for RBP, the system can also check from ledger of other peer nodes of LSFBC for EoI and LTL transactions send-by RBP to PRBP of the partner peers in SIBC for the workflow. This ensures a trust guarantee of the sensor fusion modeling process generating EoI from remote field operations into the permissioned SIBC.

At 1504, the PRBP then submits the EoI transaction to the partner peer nodes of SCaaS blockchain network for progress of the distributed workflow.

For the process illustrated in FIG. 15, some assumptions are made. One assumption is that the PRBP can check for the presence of EoI and LTL submitted by RBP in the single truth ledger of other peer nodes of the LSFBC network using quick membership presence/absence methods, such as Bloom filters. Further, depending on the desired implementation, the flow at 1503 can be optional based on requirements such as high local trust level for EoI received during live connection of remote site with PRBP in the permissioned SIBC at the remote site.

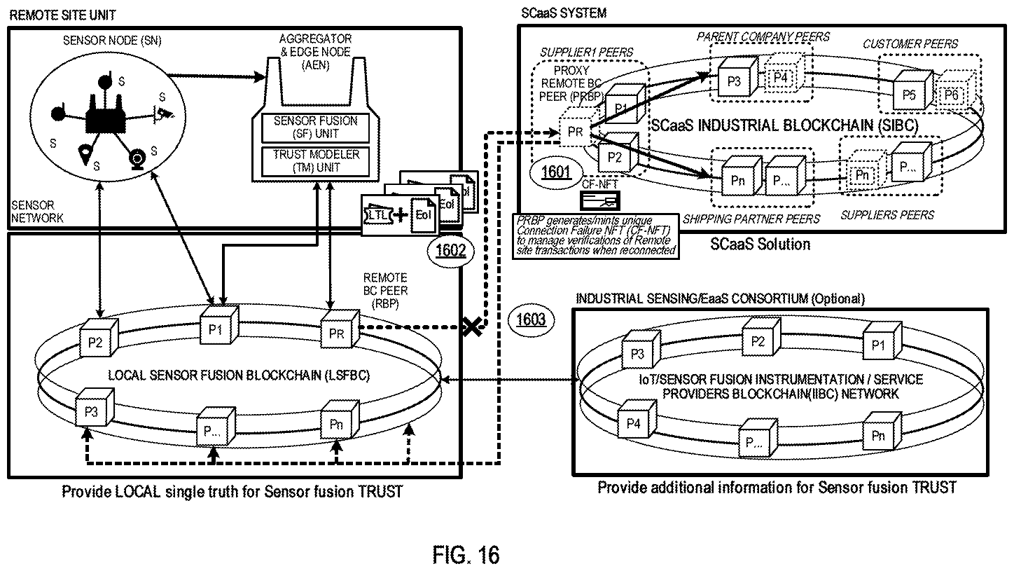

FIG. 16 illustrates an example system process for when the connection failed from the remote site to the SCaaS Blockchain Network, in accordance with an example implementation. When the connection fails from the remote site, at 1601, the PRBP detects the connection failure state at the remote site from the network status and issues/mints Connection Failed Non Fungible Token (CF-NFT) for referencing the disconnect time and duration. The CF-NFT can be used as immutable reference object for actions/status in SIBC such as store state of verifications to be done by PRBP for transactions submitted by RBP after it reconnects.

At 1602, on re-connection of the remote site, the RBP sends the missed list of EoIs and LTL to the PRBP. This list can be received in batches or serially and together with new EoI transactions can be processed concurrently as scalable design choices.

At 1603, as there was no visibility of the PRBP into the remote site during the duration of the disconnection, the PRBP requests based on CT-NFT to verify the list of transactions from other peers of the LSFBC at remote site to accept the transactions submitted by RBP. Verifications of the transaction list from LSFBC peers can have threshold for acceptance. This will resolve Byzantine peer issues of the remote site and a potential Sybil attack at the LSFBC, and guarantees that only trusted transactions are eventually submitted to the SCaaS blockchain solution.

In this process, several assumptions are made. One assumption is that the PRBP can check for the presence of the EoI and LTL submitted by the RBP in a single truth ledger of the other peer nodes of the LSFBC network using a quick membership presence/absence method such as Bloom filters. Further, there is the assumption that 1603 will be mandatory in addition to the trust model from the LTL as there was a connection failure of the remote site with the SIBC.

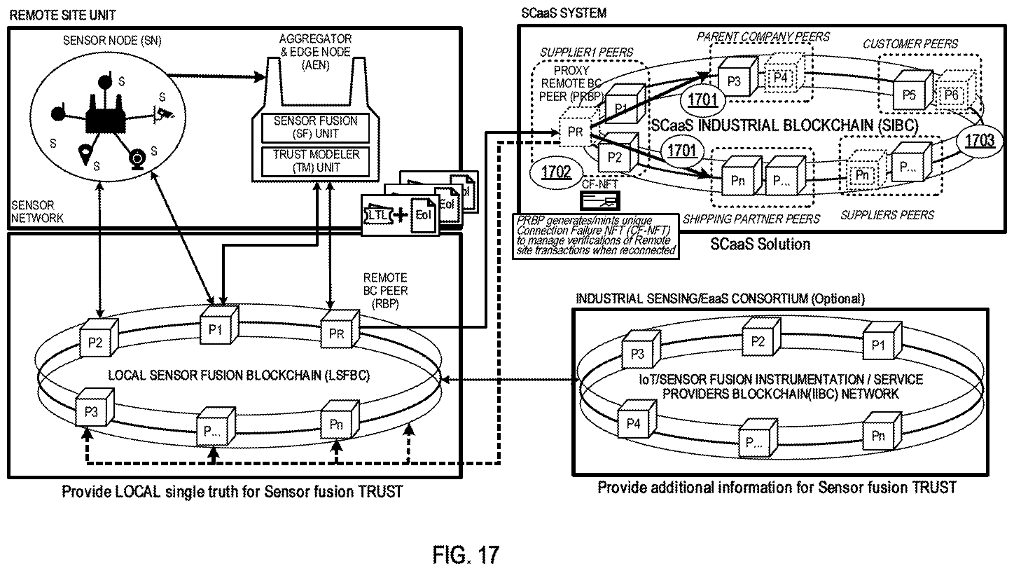

FIG. 17 illustrates an example of the system process to achieve eventual consistency for a distributed workflow among SCaaS partners in an industrial blockchain network, in accordance with an example implementation.

At 1701, the supply chain Event-of-Interest (EoI) as an output of the sensor fusion (SF) from the sensor nodes (SN) at remote sites of the partner is submitted to the SIBC to execute complex tasks of the distributed workflow among the partners in the supply chain. Hence the EoIs need to be ensured for trust, single truth and consistency by partners in SIBC to progress for the correct workflow execution. EoIs are generated from trusted (trust for identity and trust in correct sensor operations) sensing devices with tracking and traceability of the information pathways in the local sensor network at remote site for the partners/stakeholders of the SCaaS blockchain solution.

At 1702, the CT-NFT for SCaaS partners in the task of the distributed workflow is used as an immutable primary reference for a respective Task EoI submitted on the re-connection of the RBP to the PRBP. It can be used to maintain verifications from the LSFBC on reconnection to fetch track and trace of Sensor Fusion (from LSFBC) data or output transactions, and also get more Proof-of-Trust for some decisions of the associated task in the distributed workflow.

At 1703, the transactions submitted by the remote site that is outside the SIBC network thus achieves eventual consistency for the tasks of the SCaaS distributed workflow.

In this process, it is assumed that the PRBP can check the presence of the EoI and LTL submitted by the RBP in a single truth ledger of other peer nodes in LSFBC network for all transactions during the disconnection period using the CT-NFT as the immutable reference for a quick membership presence/absence using a method such as Bloom filters.

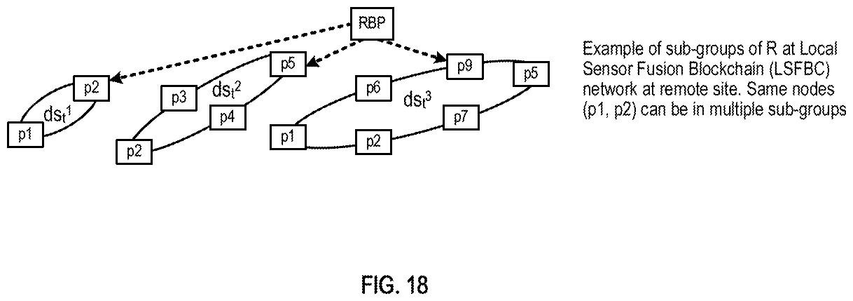

FIG. 18 illustrates an example solution formulation, in accordance with an example implementation. For the initialization and setup, let S be a set of peers in the SIBC network. Let S={P₁₁, P₁₂, . . . , Pₘₙ}, m=total number of supply chain partners, and n=total number of peer nodes in a partner's group. S forms the blockchain network with their distributed ledger having state DSₜ at time t. S is synched to the universal clock of the solution.

Further, let R be a set of peers at remote site of Pₘ setup locally for the LSFBC network. Let R={p₁, p₂, . . . , pᵣ} where r=the total number of peer nodes at remote site receiving transactions from sensor devices in the sensor network as set D={d₁, d₂, . . . , dₛ}, where s=number of sensor devices (SNs, AENs) wherein r≤s.

Let D′⊆D be subset of D having trust attributes such as ROT, attestations and so on, that are assigned/verified. R forms the local blockchain network for remote site with their distributed ledger having state dsₜ at time t.

R can as an example form at most r*((r+1)/2) sub-groups of individual blockchain network at remote site having r*((r+1)/2) distributed ledger dsₜ state (i.e at time t, dsₜ∈{dsₜ¹, dsₜ², . . . dsₜ^{r*(r+1)/2)}}). The distributed ledger states are to be synchronized locally for eventual consistency at the remote site. R is synched to the universal clock of the solution. FIG. 18 illustrates the example of sub-groups of R at the LSFBC network at the remote site. The same nodes (p1,p2) can be in multiple sub-groups as illustrated in FIG. 18

Further, let any peer node p_{qr}∈R in LSFBC network at a remote site of the partner m be assigned as Remote BC Peer (RBP). Let any peer node Pₘₙ∈S of the partner m in the SIBC network be assigned as a Proxy remote BC Peer (PRBP). Then at any time t for SCaaS Solution, there exists a connection state Cₜ of Remote BC Peer (RBP) submitting sensor network transactions as a client to the Proxy Remote BC Peer (PRBP) of SIBC network. SCaaS Solution can detect connection state Cₜ at any time t by available network connection detector solution. When there is connection failure of RBP with PRBP then the connection state changes to −Cₜ.

With regards to the remote site connection state indicating a successful operation, the sensor devices in set D at the remote site sensor network generate and process sensor data with at least one dₛ∈D having component to compute sensor fusion transaction, (i.e. Event-of-Interest E_{y} with its Trust Level TL_{y} at connection state Cₜ)

E_{y}={dₛ,val_{y},hs_{y},ts_{y}} where y=unique event id
dₛ is the device computing sensor fusion output value val_{y} computed from current sensor values and other data as needed from the LSFBC network for multiple levels of assessment
hs_{y} is the hash of any references for compute,
ts_{y} is timestamp for E_{y}
TLy={E_{y}, trustv_{y}, devicetv_{y}, datatv_{y}, ts_{y}} where E_{y} is sensor fusion Event-of-Interest for which the trust level is computed from current trust attribute values and other data as needed from the LSFBC network for trust level modeling,
   trustv_{y} is the Trust Level value
   devicetv_{y} is the device trust value (e.g. RoT)
   datatv_{y} is the sensor data trust value (correct sensor readings)
   ts_{y} is timestamp for TL_{y}
The trustv_{y} is a probability estimate (i.e. trustv_{y}=Probability (devicetv_{y}, datatv_{y}))
Then, E_{y} and TL_{y} are submitted to the LSFBC network for validation, endorsement and commitment assuming the consensus mechanism implemented for LSFBC blockchain for arriving at the distributed ledger dsₜ at time t.
   Let <E_{y}, Tl_{y}> be generated at time t during transition of dsₜ₋₁ to dsₜ

Further, the RBP is registered for observing <E_{y},TL_{y}> commit in LSFBC network. When <E_{y}, TL_{y}> are committed in LSFBC, then it sends the <E_{y}, TL_{y}> to the PRBP as a transaction for the SCaaS Blockchain (SIBC) Network. The transmission of transactions from RBP as client to PRBP is assumed to follow existing multicast or other networking protocols, thereby having a delivery guarantee delivery to PRBP.

The PRBP receives the transaction <E_{y}, TL_{y}> send by RBP. In connection state Cₜ the PRBP can request immediate presence of <E_{y}, TL_{y}> from other peers distributed ledgers {dsₜ} of LSFBC and when it receives confirmation for more than a threshold level (e.g., 50% of available peers), it can then accept the <E_{y}, TL_{y}> transaction by RBP and submit to the SIBC network.

With regards to the remote site connection state indicative of the connection failure, the SCaaS solution has a network connection detector that changes the connection Cₜ at failure time t to −Cₜ.

When −Cₜ state change is detected by the PRBP, then it issues/mints a Non-fungible Token NFTᵥ to its peer group Pₘ as NFTᵥ={Tokenidᵥ, ctimestamp, <attr₁, attr₂, . . . >} where
Tokenidᵥ is NFT unique Token ID,
ctimestamp is NFT creation time that is equivalent to the start of the connection failure time at PRBP with RBP
<attr₁, attr₂, . . . > are list of attributes at remote site to be tracked for total duration (f) of connection failure

Further, when the connection to remote site is again established, then Cₜ state change is detected by the PRBP. The RBP of the LSFBC network starts sending its transactions set:

$${E}_{y}^{t + f} = \{ < {E}_{y}^{t + 1} , {TL}_{y}^{t + 1} > , < {E}_{y}^{t + 2} , {TL}_{y}^{t + 2} > , … , < {E}_{y}^{t + f} , {TL}_{y}^{t + f} > \}$$

PRBP receives the set E_{y}^{t+f} and maps the NFTᵥ for the connection failure duration f=(NFTv<ctimestamp>)−(Cₜ<timestamp>)

PRBP then sends the request to other peers in R′={R−(RBP)} (i.e except RBP) in LSFBC for checking the presence of set E_{y}^{t+f} in their distributed ledger for the time (t+f) and any other information from the list of attributes in NFTᵥ. It collects the response for these requests as collection for NFTᵥ.

When PRBP receives presence validation of transactions in set E_{y}^{t+f} from R′ peers in LSFBC from more than a threshold level (e.g., 50%) in collection for NFTᵥ, then it can accept set filtered E_{y}^{t+f} as validated set of transactions for submission to the SIBC Network. Otherwise, EoIs can be rejected for a period of time if the local trust level is below the desired threshold.

Through the example implementations described herein, the sensing fusion network of the supply chain partner and the blockchain nodes at remote site can continue working locally during the loss of communication/connection with the SCaaS industrial blockchain consortium network and obtain an eventual consistency of the transactions (e.g. Sensor fusion events, Trust Levels and so on) for distributed workflows of SCaaS consortium.

Further, the example implementations establish a framework for the trust in sensor fusion for devices and measurement outputs submitted as transactions by remote partner sites in enterprise systems/solutions executing smart contracts to an industrial blockchain consortium blockchain, or requiring single truth for supply chain operations.

Further, the example implementations can thereby automate and gain efficiencies in distributed workflows across the supply chain network through smart contracts operating on a trusted sensor fusion, thereby enabling value added services/solutions such as end-to-end traceability and transparency and increased visibility in multi-echelon supply chain networks.

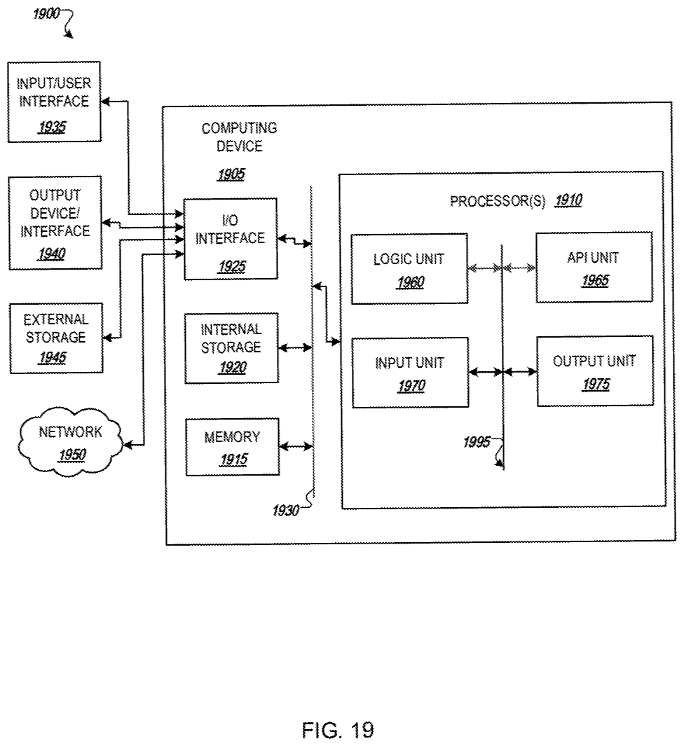

FIG. 19 illustrates an example computing environment with an example computer device suitable for use in some example implementations, such as an apparatus configured to function as a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain as illustrated and described herein. Computer device 1905 in computing environment 1900 can include one or more processing units, cores, or processors 1910, memory 1915 (e.g., RAM, ROM, and/or the like), internal storage 1920 (e.g., magnetic, optical, solid state storage, and/or organic), and/or I/O interface 1925, any of which can be coupled on a communication mechanism or bus 1930 for communicating information or embedded in the computer device 1905. I/O interface 1925 is also configured to receive images from cameras or provide images to projectors or displays, depending on the desired implementation.

Computer device 1905 can be communicatively coupled to input/user interface 1935 and output device/interface 1940. Either one or both of input/user interface 1935 and output device/interface 1940 can be a wired or wireless interface and can be detachable. Input/user interface 1935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1940 may include a display, television, monitor, printer, speaker, braille, or the like. In some example implementations, input/user interface 1935 and output device/interface 1940 can be embedded with or physically coupled to the computer device 1905. In other example implementations, other computer devices may function as or provide the functions of input/user interface 1935 and output device/interface 1940 for a computer device 1905.

Examples of computer device 1905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1905 can be communicatively coupled (e.g., via I/O interface 1925) to external storage 1945 and network 1950 for communicating with any number of networked components, devices, and systems, including one or more computer devices of the same or different configuration. Computer device 1905 or any connected computer device can be functioning as, providing services of, or referred to as a server, client, thin server, general machine, special-purpose machine, or another label.

I/O interface 1925 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1900. Network 1950 can be any network or combination of networks (e.g., the Internet, local area network, wide area network, a telephonic network, a cellular network, satellite network, and the like).

Computer device 1905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1910 can execute under any operating system (OS) (not shown), in a native or virtual environment. One or more applications can be deployed that include logic unit 1960, application programming interface (API) unit 1965, input unit 1970, output unit 1975, and inter-unit communication mechanism 1995 for the different units to communicate with each other, with the OS, and with other applications (not shown). The described units and elements can be varied in design, function, configuration, or implementation and are not limited to the descriptions provided. Processor(s) 1910 can be in the form of hardware processors such as central processing units (CPUs) or in a combination of hardware and software units.

In some example implementations, when information or an execution instruction is received by API unit 1965, it may be communicated to one or more other units (e.g., logic unit 1960, input unit 1970, output unit 1975). In some instances, logic unit 1960 may be configured to control the information flow among the units and direct the services provided by API unit 1965, input unit 1970, output unit 1975, in some example implementations described above. For example, the flow of one or more processes or implementations may be controlled by logic unit 1960 alone or in conjunction with API unit 1965. The input unit 1970 may be configured to obtain input for the calculations described in the example implementations, and the output unit 1975 may be configured to provide output based on the calculations described in example implementations.

Processor(s) 1910 can be configured to execute a method or computer instructions involving, for the PRBP detecting a connection failure for the remote blockchain node, issuing a Connection Failed Non-Fungible Token (CF-NFT) to partner peer nodes of the SCaaS blockchain as illustrated, for example at 806a of FIG. 8.

Depending on the desired implementation, the CF-NFT can include a reference for a disconnect time, a duration of the connection failure, and a state of verifications to be conducted by the PRBP for transactions submitted by the remote blockchain node after the remote blockchain reconnects as described with respect to FIGS. 16 and 17. Processor(s) 1910 can be configured to execute the methods and instructions as described herein and further involve for a reconnection of the remote blockchain node, receiving, from the remote blockchain node, missed events of interests and a local trust level at LSFBC to the PRBP; the PRBP requesting, the state of verifications associated with each of the missed events of interest from peer nodes of the LSFBC network through transmission of the CF-NFT to the peer nodes of LSFBC network as a query; and for the state of verifications of the each of the missed events of interest from the peer nodes meeting a threshold for acceptance, submitting, from the PRBP, the each of the missed events of interest to the SCaaS blockchain meeting the threshold of acceptance as described with FIGS. 16 and 17.

Depending on the desired implementation, the remote blockchain continues to operate with single truth of its operations available in the LSFBC network during the connection failure with the PRBP, wherein for a reconnection of the remote blockchain node, the remote blockchain node sends missed batches of events of interest (EoI) and local trust level (LTL) to the PRBP as described with respect to FIGS. 11 to 14.

Processor(s) 1910 can be configured to execute the method or instructions described herein, and further involve executing a sensor fusion trust modelling at an aggregator and edge network (AEN) associated with the LSFBC network, the sensor fusion trust modelling configured to compute a local trust level (LTL) for sensor fusion data received from sensors associated with the LSFBC and provide the LTL and events of interest to the remote blockchain node; wherein the LTL is computed from a distributed ledger of the LSFBC network comprising configurations and device trust data of peer nodes of the LSFBC network as described with respect to FIGS. 9 to 18.

Processor(s) 1910 can be configured to execute the method or instructions as described above, wherein the sensor fusion trust modelling of the AEN are configured to generate output transactions comprising event of interest (EoI) to be submitted to peer nodes of the LSFBC network, and for a local consensus occurring with the peer nodes of the LSFBC network, the remote blockchain nodes submits the output transactions to the PRBP as described with respect to FIGS. 9 to 18.

Processor(s) 1910 can be configured to execute the method or instructions as described above, and further involve, for the PRBP being established and connected to the remote blockchain node: receiving, from the remote blockchain node, events of interest and a local trust level at LSFBC; establishing trust in the remote blockchain node by the PBRP; and submitting the events of interest to the peer nodes of SCaaS blockchain for the trust in the remote blockchain being established as described with respect to FIGS. 9 to 18.

Processor(s) 1910 can be configured to execute the method or instructions as described above, wherein for a local trust level of the LSFBC falls below a threshold, refusing events of interest from the LSFBC for a period of time as described with respect to FIGS. 9 to 18.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (e.g., software stored on memory), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
establishing a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain; and
for the PRBP detecting a connection failure for the remote blockchain node, issuing a Connection Failed Non-Fungible Token (CF-NFT) to partner peer nodes of the SCaaS blockchain.

2. The method of claim 1, wherein the CF-NFT comprises a reference for a disconnect time, a duration of the connection failure, and a state of verifications to be conducted by the PRBP for transactions submitted by the remote blockchain node after the remote blockchain reconnects,
wherein the method further comprises:
for a reconnection of the remote blockchain node:
receiving, from the remote blockchain node, missed events of interests and a local trust level at LSFBC to the PRBP;
the PRBP requesting, the state of verifications associated with each of the missed events of interest from peer nodes of the LSFBC network through transmission of the CF-NFT to the peer nodes of LSFBC network as a query; and
for the state of verifications of the each of the missed events of interest from the peer nodes meeting a threshold for acceptance, submitting, from the PRBP, the each of the missed events of interest to the SCaaS blockchain meeting the threshold of acceptance.

3. The method of claim 2, wherein the remote blockchain continues to operate with single truth of its operations available in the LSFBC network during the connection failure with the PRBP, wherein for a reconnection of the remote blockchain node, the remote blockchain node sends missed batches of events of interest (EoI) and local trust level (LTL) to the PRBP.

4. The method of claim 1, further comprising executing a sensor fusion trust modelling at an aggregator and edge network (AEN) associated with the LSFBC network, the sensor fusion trust modelling configured to compute a local trust level (LTL) for sensor fusion data received from sensors associated with the LSFBC and provide the LTL and events of interest to the remote blockchain node;
wherein the LTL is computed from a distributed ledger of the LSFBC network comprising configurations and device trust data of peer nodes of the LSFBC network.

5. The method of claim 4, wherein the sensor fusion trust modelling of the AEN are configured to generate output transactions comprising event of interest (EoI) to be submitted to peer nodes of the LSFBC network, and
for a local consensus occurring with the peer nodes of the LSFBC network, the remote blockchain nodes submits the output transactions to the PRBP.

6. The method of claim 1, further comprising:
for the PRBP being established and connected to the remote blockchain node:
receiving, from the remote blockchain node, events of interest and a local trust level at LSFBC;
establishing trust in the remote blockchain node by the PBRP; and
submitting the events of interest to the peer nodes of SCaaS blockchain for the trust in the remote blockchain being established.

7. The method of claim 6, wherein for a local trust level of the LSFBC falls below a threshold, refusing events of interest from the LSFBC for a period of time.

8. A non-transitory computer readable medium, storing instructions for executing a process, the instructions, comprising:
establishing a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain; and
for the PRBP detecting a connection failure for the remote blockchain node, issuing a Connection Failed Non-Fungible Token (CF-NFT) to partner peer nodes of the SCaaS blockchain.

9. The non-transitory computer readable medium of claim 8, wherein the CF-NFT comprises a reference for a disconnect time, a duration of the connection failure, and a state of verifications to be conducted by the PRBP for transactions submitted by the remote blockchain node after the remote blockchain reconnects,
wherein the instructions further comprises:
for a reconnection of the remote blockchain node:
receiving, from the remote blockchain node, missed events of interests and a local trust level at LSFBC to the PRBP;
the PRBP requesting, the state of verifications associated with each of the missed events of interest from peer nodes of the LSFBC network through transmission of the CF-NFT to the peer nodes of LSFBC network as a query; and
for the state of verifications of the each of the missed events of interest from the peer nodes meeting a threshold for acceptance, submitting, from the PRBP, the each of the missed events of interest to the SCaaS blockchain meeting the threshold of acceptance.

10. The non-transitory computer readable medium of claim 9, wherein the remote blockchain continues to operate with single truth of its operations available in the LSFBC network during the connection failure with the PRBP, wherein for a reconnection of the remote blockchain node, the remote blockchain node sends missed batches of events of interest (EoI) and local trust level (LTL) to the PRBP.

11. The non-transitory computer readable medium of claim 8, further comprising executing a sensor fusion trust modelling at an aggregator and edge network (AEN) associated with the LSFBC network, the sensor fusion trust modelling configured to compute a local trust level (LTL) for sensor fusion data received from sensors associated with the LSFBC and provide the LTL and events of interest to the remote blockchain node;
wherein the LTL is computed from a distributed ledger of the LSFBC network comprising configurations and device trust data of peer nodes of the LSFBC network.

12. The non-transitory computer readable medium of claim 11, wherein the sensor fusion trust modelling of the AEN are configured to generate output transactions comprising event of interest (EoI) to be submitted to peer nodes of the LSFBC network, and for a local consensus occurring with the peer nodes of the LSFBC network, the remote blockchain nodes submits the output transactions to the PRBP.

13. The non-transitory computer readable medium of claim 8, further comprising:
for the PRBP being established and connected to the remote blockchain node:
receiving, from the remote blockchain node, events of interest and a local trust level at LSFBC;
establishing trust in the remote blockchain node by the PBRP; and
submitting the events of interest to the peer nodes of SCaaS blockchain for the trust in the remote blockchain being established.

14. The non-transitory computer readable medium of claim 8, wherein for a local trust level of the LSFBC falls below a threshold, refusing events of interest from the LSFBC for a period of time.

15. The non-transitory computer readable medium of claim 8, wherein the CF-NFT comprises a reference for a disconnect time, a duration of the connection failure, and a state of verifications to be conducted by the PRBP for transactions submitted by the remote blockchain node after the remote blockchain reconnects,
wherein the instructions further comprises:
for a reconnection of the remote blockchain node:
receiving, from the remote blockchain node, missed events of interests and a local trust level at LSFBC to the PRBP;
the PRBP requesting, the state of verifications associated with each of the missed events of interest from peer nodes of the LSFBC network through transmission of the CF-NFT to the peer nodes of LSFBC network as a query; and
for the state of verifications of the each of the missed events of interest from the peer nodes meeting a threshold for acceptance, submitting, from the PRBP, the each of the missed events of interest to the SCaaS blockchain meeting the threshold of acceptance.

16. An apparatus configured to function as a Proxy Remote Blockchain Node (PRBP) between a Local Sensor Fusion Blockchain (LSFBC) network and an industrial supply chain as a service blockchain, wherein the PRBP is connected to a remote blockchain node of the LSFBC network and configured to participate in a distributed workflow of a Supply-Chain-as-a-Service (SCaaS) blockchain, the apparatus comprising:
a processor, configured to:
for detection of a connection failure for the remote blockchain node, issuing a Connection Failed Non-Fungible Token (CF-NFT) to partner peer nodes of the SCaaS blockchain.
